(19) United States
(12) Patent Application Publication
(10) Pub. No.: US 2026/0264512 A1
(43) Pub. Date: Sep. 10, 2026

(54) SHIFTING APPARATUS

(71) Applicant: KABUSHIKI KAISHA TOKAI-RIKA-DENKI-SEISAKUSHO, Niwa-gun, Aichi (JP)

(72) Inventors: Makoto YAMAMOTO, Niwa-gun, Aichi (JP); Yutaka INAMURA, Niwa-gun, Aichi (JP); Takuya WATANABE, Niwa-gun, Aichi (JP)

(73) Assignee: KABUSHIKI KAISHA TOKAI-RIKA-DENKI-SEISAKUSHO, Niwa-gun, Aichi (JP)

(21) Appl. No.: 18/881,511

(22) PCT Filed: Jul. 10, 2023
(86) PCT No.: PCT/JP2023/025504

§ 371 Date: Jan. 6, 2025

(30) Foreign Application Priority Data
Jul. 13, 2022 (JP) 2022-112620

(51) Int. Cl. B60K 20/02; B60K 35/21

(52) U.S. Cl. CPC B60K 20/02; B60K 35/212; B60K 2360/162

(57) ABSTRACT

A shifting apparatus includes shift switches and icons. The shift switches provide operation instructions in accordance with contact by an operating hand. In a case in which operation of a shift switch is prohibited because a predetermined vehicle state is lacking, the icons, which serve as a notification unit, make a notification of the lacking vehicle state before contact of the operating hand with the shift switch.

### TECHNICAL FIELD

The present disclosure relates to a shifting apparatus.

### BACKGROUND ART

A shift-by-wire shifting apparatus is known (for example, see the Description of U.S. Patent Application Publication No. 2016/0363214) with which a shift range position may be changed by a contact from an operating hand of a driver.

The Description of U.S. Patent Application Publication No. 2016/0363214 discloses a button-type electric gear shifting apparatus in which a gear shift stage may be changed by a driver operating one or other of plural buttons to select a desired gear shift stage.

With this kind of shifting apparatus, making driving operations safer is preferable.

### SUMMARY OF INVENTION

### Technical Problem

The present disclosure provides a shifting apparatus that may make driving operations safer.

### Solution to Problem

A shifting apparatus according to a first aspect of the present disclosure includes: a shift switch that provides an operation instruction in accordance with contact of an operating hand; and a notification unit that, in a case in which operation of the shift switch is prohibited due to lack of a predetermined vehicle state, makes a notification of the lacking vehicle state before contact of the operating hand with the shift switch.

In a shifting apparatus according to a second aspect of the present disclosure, the shifting apparatus according to the first aspect of the present disclosure further includes an approach sensing unit that senses an approach of the operating hand toward the shift switch, and the notification unit makes the notification based on sensing information from the approach sensing unit.

In a shifting apparatus according to a third aspect of the present disclosure, in the shifting apparatus according to the first aspect or second aspect of the present disclosure, the predetermined vehicle state is a brake operation state.

In a shifting apparatus according to a fourth aspect of the present disclosure, in the shifting apparatus according to any one of the first to third aspects of the present disclosure, the predetermined vehicle state is a state relating to vehicle speed.

In a shifting apparatus according to a fifth aspect of the present disclosure, in the shifting apparatus according to any one of the first to fourth aspects of the present disclosure, the notification unit is an icon indicating the predetermined vehicle state.

In a shifting apparatus according to a sixth aspect of the present disclosure, in the shifting apparatus according to the fifth aspect of the present disclosure, the icon is disposed in a row with the shift switch.

In a shifting apparatus according to a seventh aspect of the present disclosure, the shifting apparatus according to any one of the first to sixth aspects of the present disclosure further includes a second notification unit that, in a case in which operation of the shift switch is prohibited due to the lack of the predetermined vehicle state, makes a notification of the shift switch whose operation is prohibited before contact of the operating hand with the shift switch.

### Advantageous Effects of Invention

In the shifting apparatus according to the first aspect of the present disclosure, in a case in which operation of the shift switch is prohibited because a predetermined vehicle state is lacking, a notification of the lacking vehicle state is made before the operating hand contacts the shift switch. Thus, a notification is made that operation of the shift switch is prohibited due to the lacking predetermined vehicle state. Therefore, a driver may be aware of the lacking vehicle state before the operating hand contacts the shift switch. As a result, the driver may perform shifting operations without becoming confused. Therefore, driving operations may be made safer.

In the shifting apparatus according to the second aspect of the present disclosure, the notification unit makes notifications based on sensing information from the approach sensing unit, and makes a notification when the operating hand approaches the shift switch. Therefore, the driver may be aware of a lacking predetermined vehicle state just before selecting a shift switch. As a result, the driver may perform shifting operations without becoming confused.

In the shifting apparatus according to the third aspect of the present disclosure, the predetermined vehicle state is a brake operation state and the notification is that a brake operation is lacking. Therefore, the driver may be aware that a brake operation is lacking before the operating hand contacts the shift switch. As a result, the driver may perform shifting operations without becoming confused.

In the shifting apparatus according to the fourth aspect of the present disclosure, the predetermined vehicle state is a state relating to vehicle speed and the notification is that the vehicle speed is too slow or that the vehicle speed is too fast. Therefore, the driver may be aware that the vehicle speed is too slow or the vehicle speed is too fast before the operating hand contacts the shift switch. As a result, the driver may perform shifting operations without becoming confused.

In the shifting apparatus according to the fifth aspect of the present disclosure, the notification unit is an icon representing the predetermined vehicle state and the notification of a lacking vehicle state is made by the icon. Therefore, the driver may see the notifying icon and identify the lacking vehicle state. As a result, the driver may perform shifting operations without becoming confused.

In the shifting apparatus according to the sixth aspect of the present disclosure, icons are disposed in a row with shift switches, and the notification of a lacking vehicle state is made by an icon in the vicinity of the shift switches. Therefore, the driver may easily observe the icon when operating a shift switch. As a result, the driver may perform shifting operations without becoming confused.

In the shifting apparatus according to the seventh aspect of the present disclosure, in a case in which operation of the shift switch is prohibited because the predetermined vehicle state is lacking, a notification of the prohibited shift switch is made before the operating hand contacts the shift switch. Thus, a notification of the prohibited shift switch is made before the shift switch is selected. Therefore, the driver may be aware of the prohibited shift switch before selecting the shift switch. As a result, the driver may perform shifting operations without becoming confused.

### BRIEF DESCRIPTION OF DRAWINGS

FIG. 1 is a schematic view, looking to the front of a vehicle from inside a vehicle cabin, showing an instrument panel at which a shifting apparatus according to a first exemplary embodiment is provided.

FIG. 2 is a perspective view showing a shifting apparatus according to the first exemplary embodiment.

FIG. 3 is a sectional diagram showing the shifting apparatus according to the first exemplary embodiment, depicting section A-A in FIG. 2.

FIG. 4 is a block diagram showing functional structures of the shifting apparatus according to the first exemplary embodiment.

FIG. 5 is a flowchart showing a flow of notification processing of the shifting apparatus according to the first exemplary embodiment.

FIG. 6 is a perspective view showing a state in which an operating hand has approached a reverse switch of the shifting apparatus according to the first exemplary embodiment.

FIG. 7 is a flowchart showing a flow of notification processing of a shifting apparatus according to a second exemplary embodiment.

FIG. 8 is a perspective view showing a state in which an operating hand has approached a reverse switch of the shifting apparatus according to the second exemplary embodiment.

FIG. 9A is a perspective view showing a state in which an operating hand has approached a reverse switch of a shifting apparatus according to an alternative embodiment.

FIG. 9B is a perspective view showing a state in which an operating hand has approached a reverse switch of a shifting apparatus according to an alternative embodiment.

FIG. 10A is a perspective view showing a state in which an operating hand has approached a reverse switch of a shifting apparatus according to an alternative embodiment.

FIG. 10B is a perspective view showing a state in which an operating hand has approached a reverse switch of a shifting apparatus according to an alternative embodiment.

### DESCRIPTION OF EMBODIMENTS

### First Exemplary Embodiment

Below, a shifting apparatus 20 according to a first exemplary embodiment is described with reference to the drawings. In the first exemplary embodiment, the shifting apparatus 20 is described as an example of a shift-by-wire shifting apparatus for a vehicle at which a shift operation is carried out by selection of a shift switch.

In the drawings, the arrow UP indicates upward in the vehicle, the arrow RH indicates rightward in the vehicle, and the arrow D indicates a longitudinal direction D of the shifting apparatus 20. Where descriptions are given simply using “one end side” and “other end side”, unless particularly specified, these are sides in the longitudinal direction D of the shifting apparatus 20.

### Structure of the Vehicle

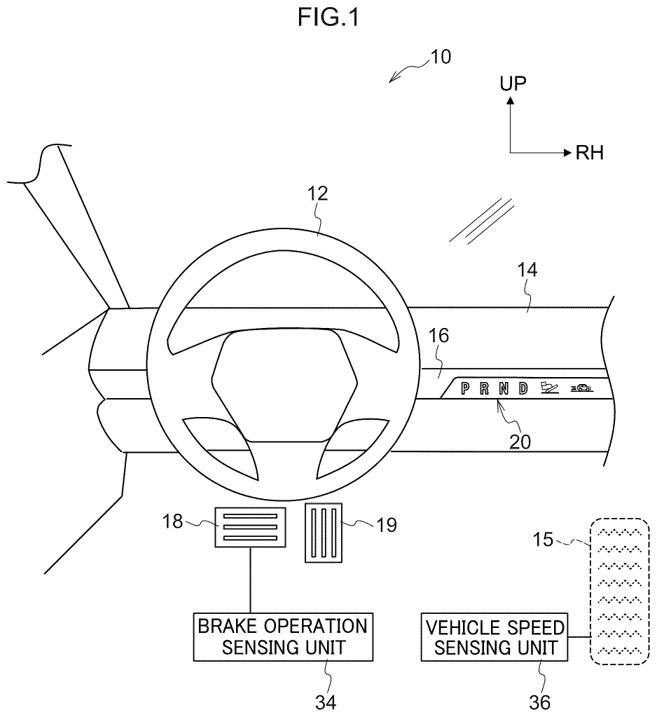

As shown in FIG. 1, a vehicle 10 according to the first exemplary embodiment is provided with a brake pedal 18, an accelerator pedal 19, a brake operation sensing unit 34 provided at the brake pedal 18, and a vehicle speed sensing unit 36 provided at a vehicle wheel 15.

The brake operation sensing unit 34 senses when the brake is operated. The brake operation sensing unit 34 may be a stroke sensor provided at the brake pedal 18. The vehicle speed sensing unit 36 senses vehicle speeds of the vehicle 10.

### Structure of the Shifting Apparatus

As shown in FIG. 1, the shifting apparatus 20 according to the first exemplary embodiment is disposed at an instrument panel 14, which is provided at the front side of a vehicle cabin interior of a vehicle 10. The shifting apparatus 20 is provided along a garnish 16 that extends in the vehicle width direction at the vehicle right side of a steering wheel 12.

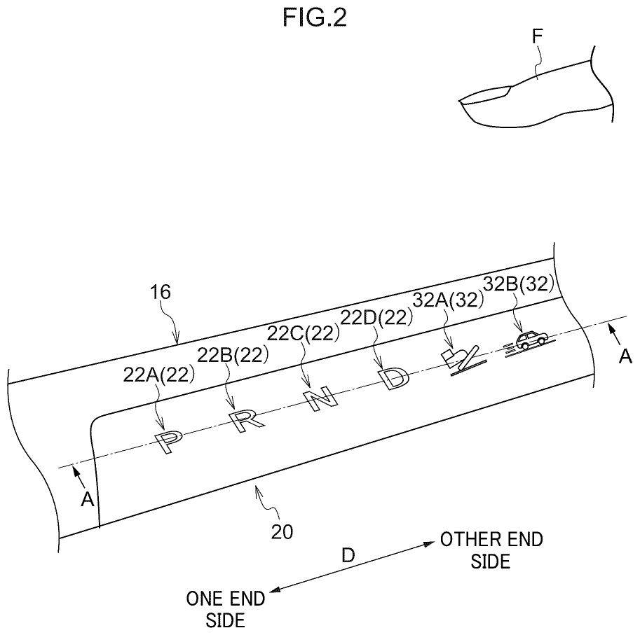

As shown in FIG. 2, as shift switches 22 of the shifting apparatus 20, a parking switch 22A, a reverse switch 22B, a neutral switch 22C and a drive switch 22D are disposed in a row from one end side to the other end side in the longitudinal direction D. A driver sits on a driver seat and, by an operating hand (finger) F of the driver contacting the shift switches 22, switches between shift range positions, which are a parking position P, a reverse position R, a neutral position N and a drive position D.

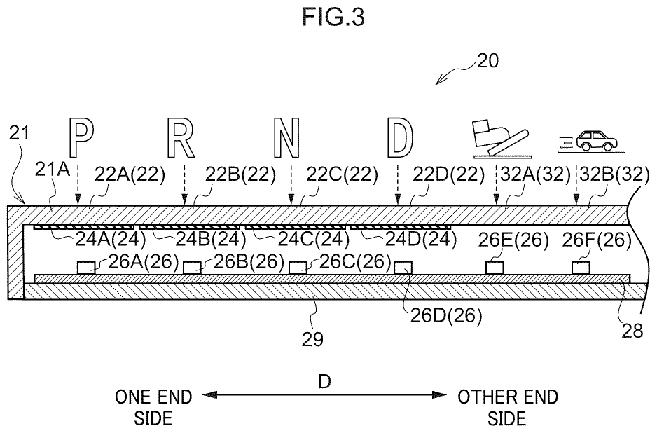

As shown in FIG. 3, the shifting apparatus 20 is provided with an upper housing 21, electrostatic sensors 24 that serve as a sensing approach unit, a printed circuit board 28, a light output unit 26, and a case 29.

### Upper Housing 21

The upper housing 21 is formed in a rectangular box shape of which one side is open. A character region P forming the letter “P”, a character region R forming the letter “R”, a character region N forming the letter “N” and a character region D forming the letter “D” are formed at the upper housing 21, at a top plate 21A structuring a design surface.

The character region P structures the parking switch 22A, the character region R structures the reverse switch 22B, the character region C structures the neutral switch 22C, and the character region D structures the drive switch 22D.

The upper housing 21 is formed with icons 32 at the top plate 21A structuring the design surface. The icons 32 indicate predetermined vehicle states. The icons 32 are disposed to be in a row at the other end side in the longitudinal direction D of the shift switches 22.

The icons 32 are provided as a first icon 32A and a second icon 32B.

The first icon 32A indicates a brake operation state. The second icon 32B indicates a state relating to vehicle speed. For example, the second icon 32B may indicate when the vehicle speed is too fast. The second icon 32B may instead indicate when the vehicle speed is too slow, and may indicate both when the vehicle speed is too fast and when the vehicle speed is too slow.

The parking switch 22A, reverse switch 22B, neutral switch 22C, drive switch 22D, first icon 32A and second icon 32B are disposed in a flat surface in a row in the longitudinal direction D.

The character region P, character region R, character region N, character region D, first icon 32A and second icon 32B of the upper housing 21 are formed to be transparent. The upper housing 21 may, for example, be formed of a transparent resin material, and a non-transparent coating may be applied to the upper housing 21 except at the character region P, character region R, character region N, character region D, first icon 32A and second icon 32B. Alternatively, the upper housing 21 may be formed of a transparent resin member to which a non-transparent film is applied with the character region P, character region R, character region N, character region D, first icon 32A and second icon 32B cut out.

### Case 29 and Printed Circuit Board 28

The case 29 is disposed so as to close off the opening of the upper housing 21. The printed circuit board 28 is disposed on an upper face of the case 29.

### Electrostatic Sensors 24

The electrostatic sensors 24 are, for example, formed to be transparent and are attached to a back face of the top plate 21A of the upper housing 21. The electrostatic sensors 24 are structured by a first electrostatic sensor 24A disposed at a position corresponding with the character region P, a second electrostatic sensor 24B disposed at a position corresponding with the character region R, a third electrostatic sensor 24C disposed at a position corresponding with the character region N, and a fourth electrostatic sensor 24D disposed at a position corresponding with the character region D.

The first electrostatic sensor 24A measures a change in electrostatic capacitance caused by an approach of the operating hand F toward the character region P. That is, the first electrostatic sensor 24A senses the approach of the operating hand F toward the parking switch 22A. The second electrostatic sensor 24B measures a change in electrostatic capacitance caused by an approach of the operating hand F toward the character region R. That is, the second electrostatic sensor 24B senses the approach of the operating hand F toward the reverse switch 22B. The third electrostatic sensor 24C measures a change in electrostatic capacitance caused by an approach of the operating hand F toward the character region N. That is, the third electrostatic sensor 24C senses the approach of the operating hand F toward the neutral switch 22C. The fourth electrostatic sensor 24D measures a change in electrostatic capacitance caused by an approach of the operating hand F toward the character region D. That is, the fourth electrostatic sensor 24D senses the approach of the operating hand F toward the drive switch 22D.

### Light Output Unit 26

The light output unit 26 is disposed on an upper face of the printed circuit board 28. The light output unit 26 may be light-emitting diodes (LEDs) that output light. The light output unit 26 is structured by a first light output portion 26A disposed at a position corresponding with the character region P, a second light output portion 26B disposed at a position corresponding with the character region R, a third light output portion 26C disposed at a position corresponding with the character region N, and a fourth light output portion 26D disposed at a position corresponding with the character region D. The light output unit 26 is also structured with a fifth light output portion 26E disposed at a position corresponding with the first icon 32A and a sixth light output portion 26F disposed at a position corresponding with the second icon 32B.

The character region P lights up when the first light output portion 26A emits light, the character region R lights up when the second light output portion 26B emits light, the character region N lights up when the third light output portion 26C emits light, the character region D lights up when the fourth light output portion 26D emits light, the first icon 32A lights up when the fifth light output portion 26E emits light, and the second icon 32B lights up when the sixth light output portion 26F emits light.

The fifth light output portion 26E and sixth light output portion 26F and the icons 32 that these light output portions light up constitute a notification unit. The first light output portion 26A to fourth light output portion 26D constitute a second notification unit.

### Functional Structures of the Shifting Apparatus

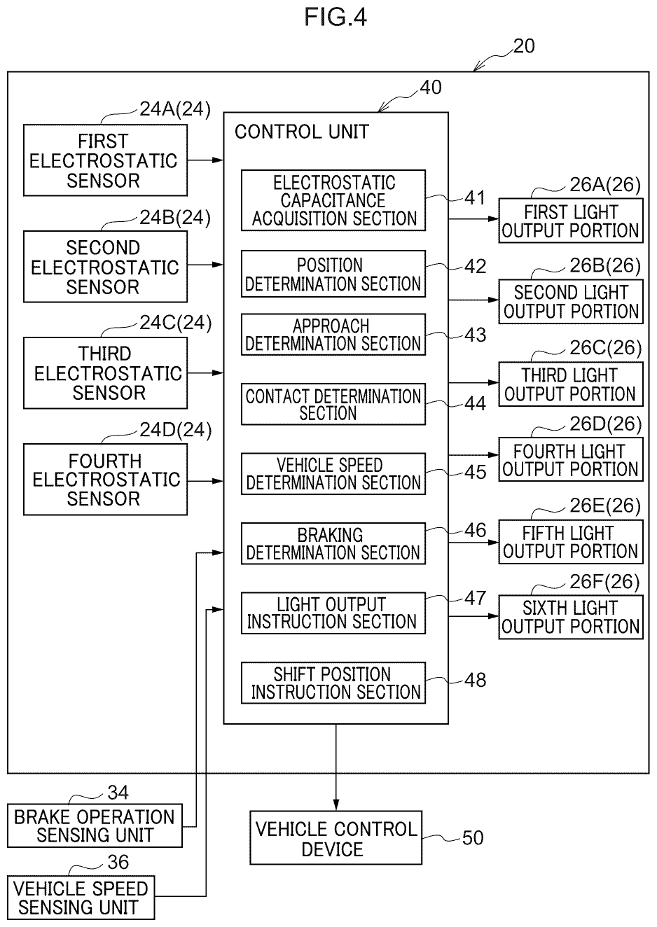

As illustrated in FIG. 4, functionally, the shifting apparatus 20 inputs sensing information from the electrostatic sensors 24, sensing information from the brake operation sensing unit 34 and sensing information from the vehicle speed sensing unit 36 to a control unit 40 and outputs information processed by the control unit 40 to the light output unit 26 and a vehicle control device 50.

The first electrostatic sensor 24A measures a change in electrostatic capacitance caused by an approach of the operating hand F toward the character region P. Measurement information from the first electrostatic sensor 24A is inputted to the control unit 40. The second electrostatic sensor 24B measures a change in electrostatic capacitance caused by an approach of the operating hand F toward the character region R. Measurement information from the second electrostatic sensor 24B is inputted to the control unit 40. The third electrostatic sensor 24C measures a change in electrostatic capacitance caused by an approach of the operating hand F toward the character region N. Measurement information from the third electrostatic sensor 24C is inputted to the control unit 40. The fourth electrostatic sensor 24D measures a change in electrostatic capacitance caused by an approach of the operating hand F toward the character region D. Measurement information from the fourth electrostatic sensor 24D is inputted to the control unit 40.

The brake operation sensing unit 34 senses when brake operations are performed, and sensing information from the brake operation sensing unit 34 is inputted to the control unit 40. The vehicle speed sensing unit 36 senses vehicle speeds of the vehicle 10, and sensing information from the vehicle speed sensing unit 36 is inputted to the control unit 40.

The control unit 40 is provided with an electrostatic capacitance acquisition section 41, a position determination section 42, an approach determination section 43, a contact determination section 44, a vehicle speed determination section 45, a braking determination section 46, a light output instruction section 47 and a shift position instruction section 48.

The electrostatic capacitance acquisition section 41 acquires electrostatic capacitances sensed by the electrostatic sensors 24.

The position determination section 42 determines a shift range position in accordance with the electrostatic sensors 24 sensing electrostatic capacitances. More specifically, when the first electrostatic sensor 24A senses a change in electrostatic capacitance, the position determination section 42 determines that the shift range position is the parking position P. When the second electrostatic sensor 24B senses a change in electrostatic capacitance, the position determination section 42 determines that the shift range position is the reverse position R. When the third electrostatic sensor 24C senses a change in electrostatic capacitance, the position determination section 42 determines that the shift range position is the neutral position N. When the fourth electrostatic sensor 24D senses a change in electrostatic capacitance, the position determination section 42 determines that the shift range position is the drive position D.

Based on electrostatic capacitances acquired by the electrostatic capacitance acquisition section 41, the approach determination section 43 determines whether or not the operating hand F has approached into a predetermined range from the shift switches 22 (for example, 2 to 3 cm). More specifically, the approach determination section 13 determines whether or not an electrostatic capacitance acquired by the electrostatic capacitance acquisition section 11 is greater than a predetermined threshold value A.

Based on electrostatic capacitances acquired by the electrostatic capacitance acquisition section 41, the contact determination section 44 determines whether or not the operating hand F is in contact with the shift switches 22. More specifically, the contact determination section 44 determines whether or not an electrostatic capacitance acquired by the electrostatic capacitance acquisition section 41 is greater than a predetermined threshold value B.

The vehicle speed determination section 45 determines whether or not a vehicle speed of the vehicle 10 is slower than a predetermined vehicle speed C.

Based on sensing information from the brake operation sensing unit 34, the braking determination section 46 determines whether or not a brake operation is being performed.

Based on a determination result from the position determination section 42 and a determination result from the approach determination section 43, the light output instruction section 47 lights up or flashes one of the first light output portion 26A to fourth light output portion 26D.

More specifically, when the position determination section 42 determines that a shift range position is the parking position P and the approach determination section 43 determines that the operating hand F has approached into the predetermined range (for example, 2 to 3 cm) from the shift switches 22, the light output instruction section 47 provides an output instruction to the first light output portion 26A. When the position determination section 42 determines that the shift range position is the reverse position R and the approach determination section 43 determines that the operating hand F has approached into the predetermined range (for example, 2 to 3 cm) from the shift switches 22, the light output instruction section 47 provides an output instruction to the second light output portion 26B. When the position determination section 42 determines that the shift range position is the neutral position N and the approach determination section 43 determines that the operating hand F has approached into the predetermined range (for example, 2 to 3 cm) from the shift switches 22, the light output instruction section 47 provides an output instruction to the third light output portion 26C. When the position determination section 42 determines that the shift range position is the drive position D and the approach determination section 43 determines that the operating hand F has approached into the predetermined range (for example, 2 to 3 cm) from the shift switches 22, the light output instruction section 47 provides an output instruction to the fourth light output portion 26D.

Based on a determination result from the position determination section 42 and a determination result from the vehicle speed determination section 45 or a determination result from the braking determination section 46, the light output instruction section 47 lights the fifth light output portion 26E or the sixth light output portion 26F.

Based on a determination result from the position determination section 42 and a determination result from the contact determination section 44, the shift position instruction section 48 provides a predetermined command to the vehicle control device 50.

More specifically, when the position determination section 42 determines that the shift range position is the parking position P and the contact determination section 44 determines that the operating hand F has made contact with that shift switch 22, the shift position instruction section 48 provides a parking position P instruction to the vehicle control device 50. When the position determination section 42 determines that the shift range position is the reverse position R and the contact determination section 44 determines that the operating hand F has made contact with that shift switch 22, the shift position instruction section 48 provides a reverse position R instruction to the vehicle control device 50. When the position determination section 42 determines that the shift range position is the neutral position N and the contact determination section 44 determines that the operating hand F has made contact with that shift switch 22, the shift position instruction section 48 provides a neutral position N instruction to the vehicle control device 50. When the position determination section 42 determines that the shift range position is the drive position D and the contact determination section 44 determines that the operating hand F has made contact with that shift switch 22, the shift position instruction section 48 provides a drive position D instruction to the vehicle control device 50.

### Flow of Notification Processing by the Shifting Apparatus

Below, as an example of notification processing of the shifting apparatus 20, a situation is described in which, from a state in which a shift range position is the parking position P, the operating hand F selects the reverse position R.

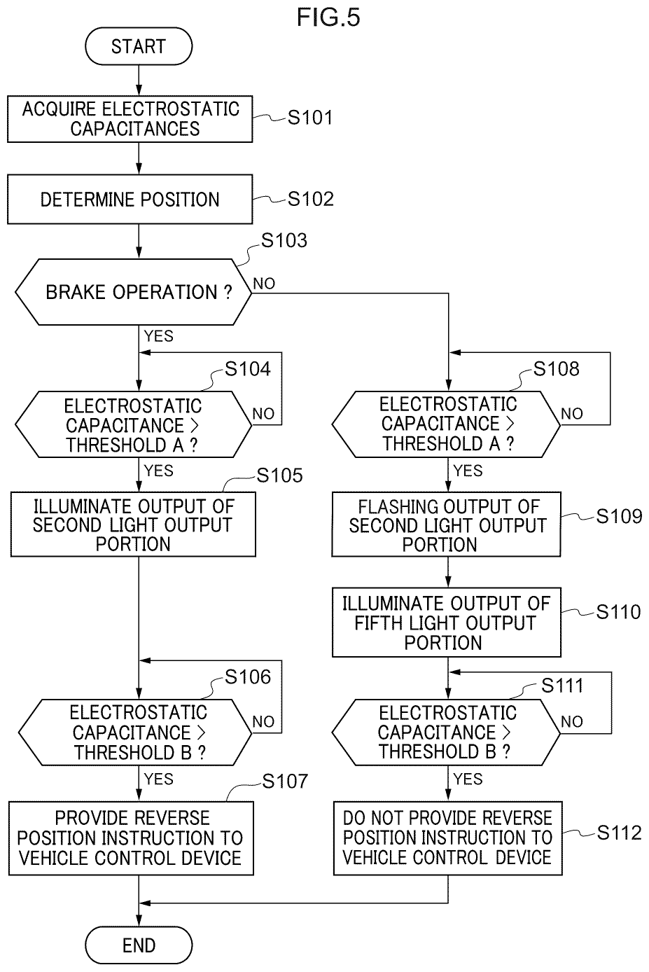

When the notification processing as illustrated in FIG. 5 is started, the electrostatic capacitance acquisition section 41 acquires electrostatic capacitances sensed by the electrostatic sensors 24 (step S101).

The position determination section 42 determines a shift range position in accordance with the electrostatic sensors 24 sensing electrostatic capacitances (step S102).

Then the braking determination section 46 makes a determination as to whether a brake operation is being performed (step S103) based on sensing information from the brake operation sensing unit 34. When the braking determination section 46 determines that a brake operation is being performed (YES in step S103), the control unit 40 proceeds to step S104. Alternatively, when the braking determination section 46 determines that no brake operation is being performed (NO in step S103), the control unit 40 proceeds to step S108.

When the control unit 40 proceeds to step S104, the approach determination section 43 makes a determination as to whether an electrostatic capacitance acquired by the electrostatic capacitance acquisition section 41 is greater than the predetermined threshold value A (step S104). When the approach determination section 33 determines that the electrostatic capacitance is greater than the predetermined threshold value A (YES in step S104), the control unit 40 proceeds to step S105. Alternatively, when the approach determination section 33 determines that the electrostatic capacitance is smaller than the predetermined threshold value A (NO in step S104), the control unit 40 returns to step S104.

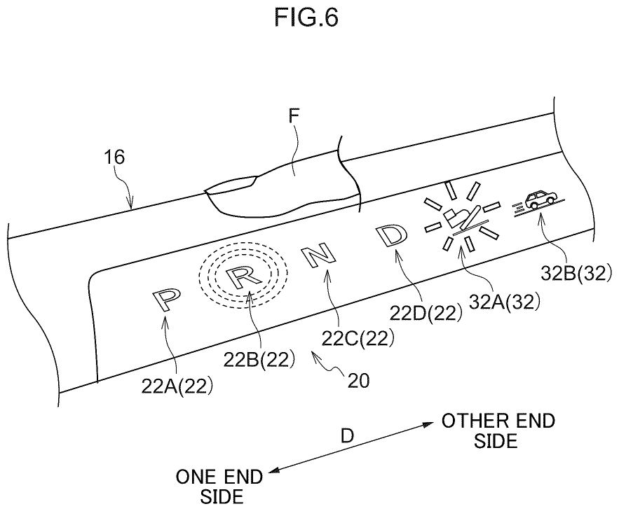

When the control unit 40 proceeds to step S105, the light output instruction section 47 provides an illumination output instruction to the second light output portion 26A. As a result, the first light output portion 26A clearly shows the reverse switch 22B, making a notification (see FIG. 6).

Then the contact determination section 44 makes a determination as to whether an electrostatic capacitance acquired by the electrostatic capacitance acquisition section 41 is greater than the predetermined threshold value B (step S106). When the contact determination section 44 determines that the electrostatic capacitance is greater than the predetermined threshold value B (YES in step S106), the control unit 40 proceeds to step S107. Alternatively, when the contact determination section 44 determines that the electrostatic capacitance is smaller than the predetermined threshold value B (NO in step S106), the control unit 40 returns to step S106.

When the control unit 40 proceeds to step S107, the shift position instruction section 48 provides a reverse position R instruction to the vehicle control device 50 and the notification processing ends.

On the other hand, when the control unit 40 proceeds to step S108, the approach determination section 43 makes a determination as to whether an electrostatic capacitance acquired by the electrostatic capacitance acquisition section 41 is greater than the predetermined threshold value A (step S108). When the approach determination section 43 determines that the electrostatic capacitance is greater than the predetermined threshold value A (YES in step S108), the control unit 40 proceeds to step S109. Alternatively, when the approach determination section 43 determines that the electrostatic capacitance is smaller than the predetermined threshold value A (NO in step S108), the control unit 40 returns to step S108.

When the control unit 40 proceeds to step S109, the light output instruction section 47 provides a flashing output instruction to the second light output portion 26A. That is, even when operation of the reverse switch 22B is prohibited because a brake operation is lacking, the light output instruction section 47 makes a notification at the reverse switch 22B whose operation is prohibited before the operating hand F contacts the reverse switch 22B (see FIG. 6).

Then the light output instruction section 47 provides an illumination output instruction to the fifth light output portion 26E (step S110). As a result, the first icon 32A lights up (see FIG. 6). That is, when operation of the reverse switch 22B is prohibited because a brake operation is lacking, the light output instruction section 47 makes a notification that a brake operation is lacking before the operating hand F contacts the reverse switch 22B (see FIG. 6).

Then the contact determination section 44 makes a determination as to whether an electrostatic capacitance acquired by the electrostatic capacitance acquisition section 41 is greater than the predetermined threshold value B (step S111). When the contact determination section 44 determines that the electrostatic capacitance is greater than the predetermined threshold value B (YES in step S111), the control unit 40 proceeds to step S112. Alternatively, when the contact determination section 44 determines that the electrostatic capacitance is smaller than the predetermined threshold value B (NO in step S111), the control unit 40 returns to step S111.

When the control unit 40 proceeds to step S112, the shift position instruction section 48 does not provide the reverse position R instruction to the vehicle control device 50 and the notification processing ends.

### Operation of the First Exemplary Embodiment

The shifting apparatus 20 according to the first exemplary embodiment includes (see FIG. 6) the shift switches 22 that provide operation instructions in accordance with contact by an operating hand F and the icons 32 serving as a notification unit that, when operation of one of the shift switches 22 is prohibited because a brake operation is lacking, make a notification that the lacking predetermined vehicle state is a brake operation before the operating hand F contacts that shift switch 22.

In a lever-type shifting apparatus, disabling of an operation may be identified from a shift lock or the like. By contrast, in an apparatus with touch-type shift switches, disabling of operation of a shift switch because a predetermined vehicle state is lacking may be difficult for a driver to comprehend.

In the first exemplary embodiment, when operation of at least one of the shift switches 22 is prohibited because a brake operation is lacking, a notification of the lacking brake operation is made before the operating hand F contacts the shift switch 22. Thus, a notification is made that operation of the shift switch 22 is prohibited because a brake operation is lacking. Therefore, the driver may be aware of the lacking brake operation before the operating hand F contacts the shift switch 22. As a result, the driver may perform shifting operations without becoming confused. Therefore, driving operations may be made safer.

The shifting apparatus 20 according to the first exemplary embodiment includes (see FIG. 3) the electrostatic sensors 24 that serve as an approach sensing unit sensing an approach of the operating hand F toward the shift switches 22. The icons 32 make a notification based on sensing information from the electrostatic sensors 24.

Because the icons 32 make a notification based on sensing information from the electrostatic sensors 24, the icons 32 can make a notification when the operating hand F approaches the shift switches 22. Therefore, the driver may be aware of a lacking brake operation just before selecting from the shift switches 22. As a result, the driver may perform shifting operations without becoming confused.

In the shifting apparatus 20 according to the first exemplary embodiment, the icons 32 are disposed in a row with the shift switches 22 (see FIG. 6).

Because the icons 32 are arranged in a row with the shift switches 22, a notification of a lacking brake operation by the icons 32 is made in the vicinity of the shift switches 22. Consequently, the driver can easily observe the icons 32 when operating the shift switches 22. As a result, the driver may perform shifting operations without becoming confused.

The shifting apparatus 20 according to the first exemplary embodiment includes the first light output portion 26A to fourth light output portion 26D (see FIG. 6) that serve as the second notification unit that, when operation of one of the shift switches 22 is prohibited because a brake operation is lacking, makes a notification of the prohibited shift switch 22 before the operating hand F contacts that shift switch 22.

When operation of one of the shift switches 22 is prohibited because a brake operation is lacking, a notification is made for that shift switch 22 before the operating hand F contacts that shift switch 22. Thus, the notification of the shift switch 22 whose operation is prohibited is made before the shift switch 22 is selected. Therefore, the driver may be aware of the shift switch 22 whose operation is prohibited before selecting the shift switch 22. As a result, the driver may perform shifting operations without becoming confused.

### Second Exemplary Embodiment

A shifting apparatus according to a second exemplary embodiment differs from the shifting apparatus according to the first exemplary embodiment in that the lacking vehicle state is different.

Below, structures of the shifting apparatus according to the second exemplary embodiment are described. Descriptions of portions whose details are the same as or equivalent to the details described for the first exemplary embodiment are given using the same terminology and reference symbols.

### Flow of Notification Processing by the Shifting Apparatus

Below, as an example of notification processing of the shifting apparatus 20, a situation is described in which, from a state in which a shift range position is the parking position P, the operating hand F selects the reverse position R.

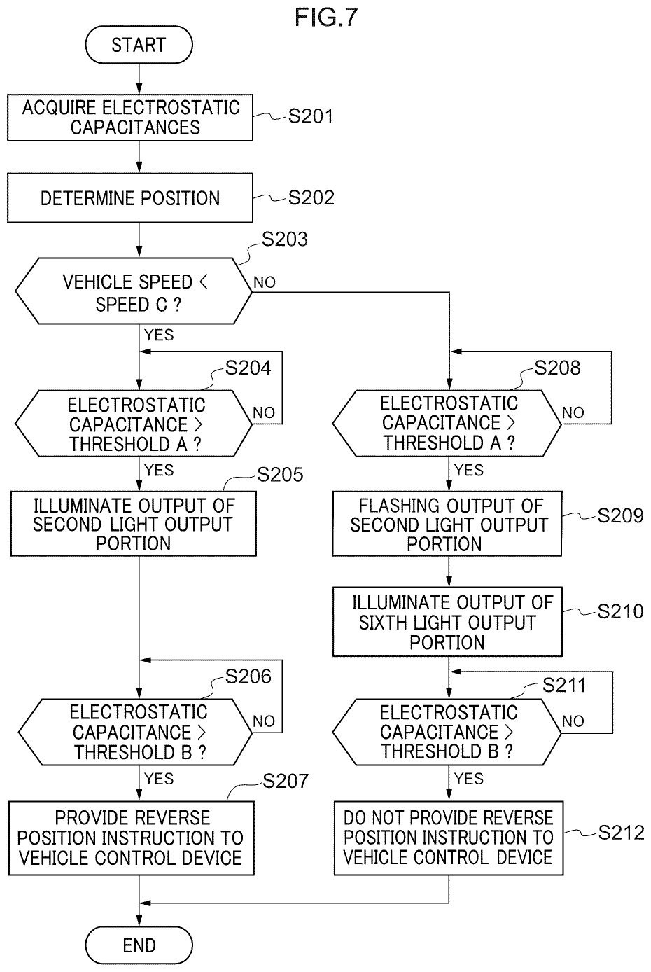

When the notification processing as illustrated in FIG. 7 is started, the electrostatic capacitance acquisition section 41 acquires electrostatic capacitances sensed by the electrostatic sensors 24 (step S201).

The position determination section 42 determines a shift range position in accordance with the electrostatic sensors 24 sensing electrostatic capacitances (step S202).

Then the vehicle speed determination section 45 makes a determination as to whether a vehicle speed of the vehicle 10 is slower than a vehicle speed C (step S203). When the vehicle speed determination section 45 determines that the vehicle speed of the vehicle 10 is slower than the vehicle speed C (YES in step S203), the control unit 40 proceeds to step S204. Alternatively, when the vehicle speed determination section 45 determines that the vehicle speed of the vehicle 10 is faster than the vehicle speed C (NO in step S203), the control unit 40 proceeds to step S208.

When the control unit 40 proceeds to step S204, the approach determination section 43 makes a determination as to whether an electrostatic capacitance acquired by the electrostatic capacitance acquisition section 41 is greater than the predetermined threshold value A (step S204). When the approach determination section 43 determines that the electrostatic capacitance is greater than the predetermined threshold value A (YES in step S204), the control unit 40 proceeds to step S205. Alternatively, when the approach determination section 33 determines that the electrostatic capacitance is smaller than the predetermined threshold value A (NO in step S204), the control unit 40 returns to step S204.

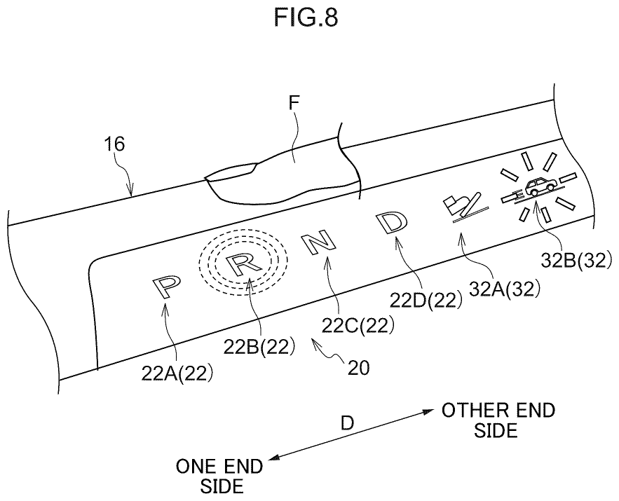

When the control unit 40 proceeds to step S205, the light output instruction section 47 provides an illumination output instruction to the second light output portion 26A. As a result, the first light output portion 26A clearly shows the reverse switch 22B, making a notification (see FIG. 8).

Then the contact determination section 44 makes a determination as to whether an electrostatic capacitance acquired by the electrostatic capacitance acquisition section 41 is greater than the predetermined threshold value B (step S206). When the contact determination section 44 determines that the electrostatic capacitance is greater than the predetermined threshold value B (YES in step S206), the control unit 40 proceeds to step S207. Alternatively, when the contact determination section 44 determines that the electrostatic capacitance is smaller than the predetermined threshold value B (NO in step S206), the control unit 40 returns to step S206.

When the control unit 40 proceeds to step S207, the shift position instruction section 48 provides a reverse position R instruction to the vehicle control device 50 and the notification processing ends.

On the other hand, when the control unit 40 proceeds to step S208, the approach determination section 43 makes a determination as to whether an electrostatic capacitance acquired by the electrostatic capacitance acquisition section 41 is greater than the predetermined threshold value A (step S208). When the approach determination section 43 determines that the electrostatic capacitance is greater than the predetermined threshold value A (YES in step S208), the control unit 40 proceeds to step S209. Alternatively, when the approach determination section 43 determines that the electrostatic capacitance is smaller than the predetermined threshold value A (NO in step S208), the control unit 40 returns to step S208.

When the control unit 40 proceeds to step S209, the light output instruction section 47 provides a flashing output instruction to the second light output portion 26A. That is, when operation of the reverse switch 22B is prohibited because the vehicle speed is too fast, The light output instruction section 47 makes a notification of the reverse switch 22B whose operation is prohibited before the operating hand F contacts the reverse switch 22B (see FIG. 8).

Then the light output instruction section 47 provides an illumination output instruction to the sixth light output portion 26F (step S210). As a result, the second icon 32B lights up (see FIG. 8). That is, when operation of the reverse switch 22B is prohibited because the vehicle speed is too fast, the light output instruction section 47 makes a notification that the vehicle speed is too fast before the operating hand F contacts the reverse switch 22B (see FIG. 8).

Then the contact determination section 44 makes a determination as to whether an electrostatic capacitance acquired by the electrostatic capacitance acquisition section 41 is greater than the predetermined threshold value B (step S211). When the contact determination section 44 determines that the electrostatic capacitance is greater than the predetermined threshold value B (YES in step S211), the control unit 40 proceeds to step S212. Alternatively, when the contact determination section 44 determines that the electrostatic capacitance is smaller than the predetermined threshold value B (NO in step S211), the control unit 40 returns to step S211.

When the control unit 40 proceeds to step S212, the shift position instruction section 48 does not provide the reverse position R instruction to the vehicle control device 50 and the notification processing ends.

### Operation of the Second Exemplary Embodiment

In the shifting apparatus 20 according to the second exemplary embodiment, the lacking predetermined vehicle state is a state relating to vehicle speed (see FIG. 8).

Because the lacking predetermined vehicle state is a state relating to vehicle speed, a notification is made that a vehicle speed is too slow or a vehicle speed is too fast. Therefore, the driver may be aware that the vehicle speed is too slow or the vehicle speed is too fast before the operating hand F contacts the shift switches 22. As a result, the driver may perform shifting operations without becoming confused.

Other structures and operational effects are substantially the same as in the first exemplary embodiment described above and accordingly are not described here.

While the shifting apparatus of the present disclosure is described above in accordance with the first exemplary embodiment and the second exemplary embodiment, specific structures are not limited by this exemplary embodiment. Design changes and the like that do not depart from the gist of the invention according to the scope of the attached claims may be embodied.

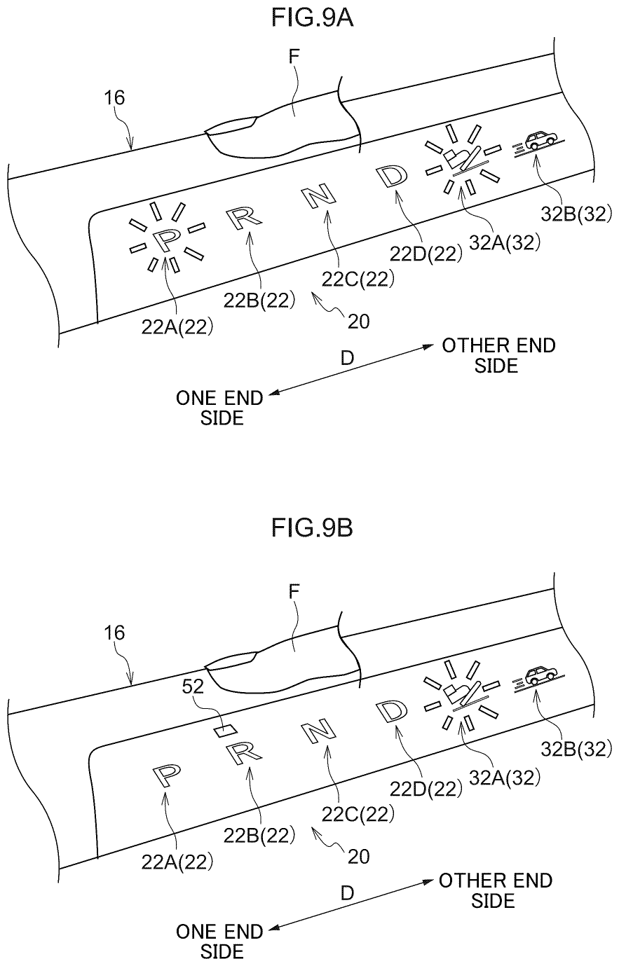

In the first exemplary embodiment and second exemplary embodiment, examples are described in which, when the operating hand F approaches the shift switch 22 whose operation is prohibited, the shift switch 22 that the operating hand F is approaching flashes. However, as illustrated in FIG. 9A, when the operating hand F approaches the shift switch 22 whose operation is prohibited (for example, the reverse switch 22B), a currently selected one of the shift switches 22 (for example, the parking switch 22A) may be lit up.

As illustrated in FIG. 9B, when the operating hand F approaches the shift switch 22 whose operation is prohibited (for example, the reverse switch 22B), an indicator 52 indicating the shift switch 22 that the operating hand F is approaching (for example, the parking switch 22A) may be lit.

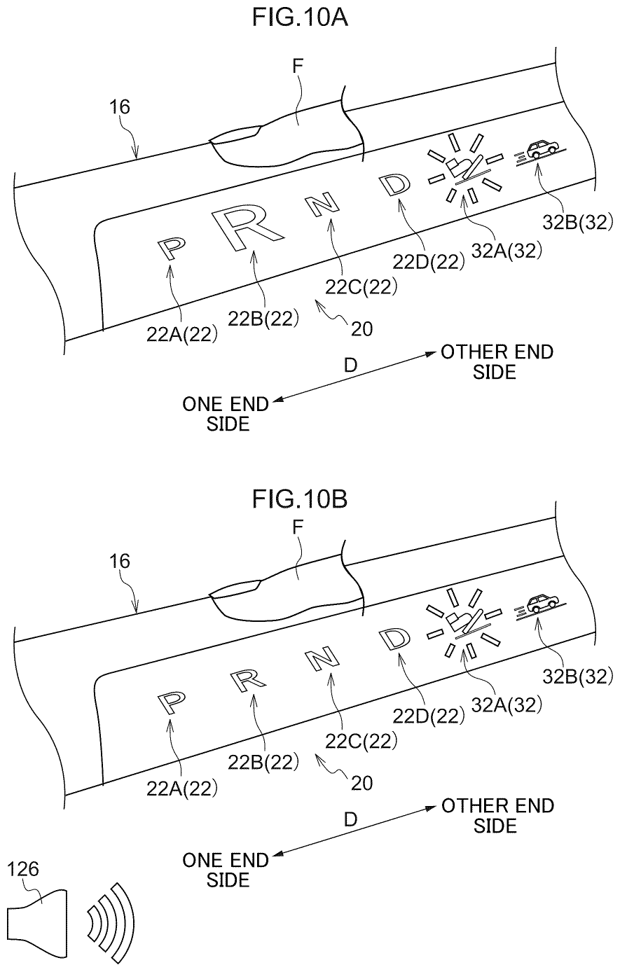

As illustrated in FIG. 10A, if the shifting apparatus 20 is formed as a touch panel, when the operating hand F approaches the shift switch 22 whose operation is prohibited (for example, the reverse switch 22B), the shift switch 22 that the operating hand F is approaching (for example, the parking switch 22A) may be shown enlarged.

When the shifting apparatus 20 is formed as a touch panel and the operating hand F approaches the shift switch 22 whose operation is prohibited (for example, the reverse switch 22B), the shift switch 22 that the operating hand F is approaching (for example, the parking switch 22A) may be lit up in an altered color.

Further, when the shifting apparatus 20 is formed as a touch panel and the operating hand F approaches the shift switch 22 whose operation is prohibited (for example, the reverse switch 22B), all of the shift switches 22 may be flashed or lit up.

In the first exemplary embodiment and second exemplary embodiment, examples are illustrated in which the notification unit is the icons 32 indicating predetermined vehicle states. However, as illustrated in FIG. 10B, the notification unit may be a sound output unit 126 that outputs sound. In this case, when operation of the reverse switch 22B is prohibited because a brake operation is lacking and the operating hand F approaches the reverse switch 22B whose operation is prohibited, the sound output unit 126 may output a voice message, “press the brake pedal”.

In the first exemplary embodiment and second exemplary embodiment, examples are illustrated in which, when operation of one of the shift switches 22 is prohibited because a predetermined vehicle state is lacking, a notification of the lacking vehicle state is made when the operating hand F approaches the shift switch 22. However, a notification of a lacking vehicle state may be made after the operating hand F contacts the shift switch 22. Further, an icon may be lit up when a brake operation is not performed or when a vehicle speed is too slow or a vehicle speed is too fast, regardless of shifting operations.

In the first exemplary embodiment, an example is illustrated in which operation of the reverse switch 22B is prohibited when a brake operation is not performed. However, operation of the neutral switch 22C and the drive switch 22D may also be prohibited when a brake operation is not performed.

In the second exemplary embodiment, an example is illustrated in which operation of the reverse switch 22B is prohibited when the vehicle speed is faster than the predetermined speed C. However, operation of the parking switch 22A may also be prohibited when the vehicle speed is faster than a predetermined speed C. Further, operations of a manual switch (M switch) may be prohibited when the vehicle speed is slower than a predetermined speed C.

In the first exemplary embodiment and second exemplary embodiment, examples are illustrated in which the predetermined vehicle states are a brake operation state and a state relating to vehicle speed. However, predetermined vehicle states are not limited by these modes.

In the first exemplary embodiment and second exemplary embodiment, examples are illustrated in which the shift switches 22 and the icons 32 are disposed in a row in the vehicle width direction. However, the shift switches may be disposed in a row in the vehicle vertical direction, or may be disposed in an “L” shape, a cross shape or a ring shape. Further, the icons may be provided at a separate location from the shift switches 22 (for example, at an instrument display).

In the first exemplary embodiment and second exemplary embodiment, examples are illustrated in which the approach sensing unit is the electrostatic sensors 24. However, it is sufficient that the approach sensing unit is capable of sensing approaches of the operating hand F toward the shift switches 22. The approach sensing unit may be, for example, a camera.

The exemplary embodiments described above illustrate examples in which the shifting apparatus 20 is disposed at the instrument panel 14. However, the shifting apparatus may be disposed at a center console, the steering wheel, or an alternative component in the vehicle cabin.

The disclosures of Japanese Patent Application No. 2022-112620 filed Jul. 13, 2022 are incorporated into the present specification by reference in their entirety.

All references, patent applications and technical specifications cited in the present specification are incorporated by reference into the present specification to the same extent as if the individual references, patent applications and technical specifications were specifically and individually recited as being incorporated by reference.

1. A shifting apparatus, comprising:
a shift switch that provides an operation instruction in accordance with contact of an operating hand; and
a notification unit that, in a case in which operation of the shift switch is prohibited due to lack of a predetermined vehicle state, makes a notification of the lacking vehicle state before contact of the operating hand with the shift switch.

2. The shifting apparatus according to claim 1, further comprising an approach sensing unit that senses an approach of the operating hand toward the shift switch,
wherein the notification unit makes the notification based on sensing information from the approach sensing unit.

3. The shifting apparatus according to claim 1, wherein the predetermined vehicle state is a brake operation state.

4. The shifting apparatus according to claim 1, wherein the predetermined vehicle state is a state relating to vehicle speed.

5. The shifting apparatus according to claim 1, wherein the notification unit is an icon indicating the predetermined vehicle state.

6. The shifting apparatus according to claim 5, wherein the icon is disposed in a row with the shift switch.

7. The shifting apparatus according to claim 1, further comprising a second notification unit that, in a case in which operation of the shift switch is prohibited due to the lack of the predetermined vehicle state, makes a notification of the shift switch whose operation is prohibited before contact of the operating hand with the shift switch.
